(19) United States
(12) Patent Application Publication
(10) Pub. No.: US 2003/0209406 A1
(43) Pub. Date: Nov. 13, 2003

(54) Apparatus for sorting pouched articles

(76) Inventor: David A. Jones, Richmond Hill (CA)

Correspondence Address: GOWLING LAFLEUR HENDERSON LLP, COMMERCE COURT WEST, SUITE 4900, TORONTO, ON, M5L 1J3, CA

(21) Appl. No.: 10/140,986

(22) Filed: May 9, 2002

(51) Int. Cl. B65G 47/14; B65G 47/30

(52) U.S. Cl. 198/443; 198/459.1; 198/396

(57) ABSTRACT

An apparatus for sorting pouched articles has a plurality of inclined conveyors arranged sequentially for each conveyor in turn to transport the articles up a respective incline and drop each article onto an adjacent conveyor. Each conveyor has an incline and a coefficient of friction sufficient to cause overlying articles to slide back down relative to underlying articles as the underlying articles are pulled up the incline by the conveyor. Each conveyor is independently actuatable. A respective article detector detects presence or non-presence of an article on each conveyor. Each conveyor is stopped until at least an adjacent conveyor ahead thereof is clear of any articles.

### FIELD OF THE INVENTION

This invention relates to an apparatus for sorting articles. More specifically, the present invention relates to an apparatus for orienting and sorting pouched articles.

### BACKGROUND OF THE INVENTION

Many products are packaged in flexible pouches or sealed bags or envelopes. Typically such pouches are of a rectangular shape and may contain food products, such as seasonings, salad dressings, cereals and candies. By way of example, a salad kit may include a foil pouch of salad dressing, a cellophane pouch of croutons, foil envelope with seasonings, all of which is packaged in a cellophane bag of chopped lettuce and other salad greens. If each of these items is to be hand sorted and manually placed within the cellophane bag for sealing, the reliance on manual labour will increase the packaging time and cost.

There are numerous challenges associated with orienting and separating pouched articles. For example, the flexibility of the pouch allows it to change shape as it is handled. This will result in clumping together of pouches which may prevent effective sorting and handling. One apparatus for separating and orienting pouched articles is disclosed in my earlier U.S. Pat. No. 6,267,224. In that patent, an inclined conveyor is utilized which has an inclination sufficient to cause an overlying flexible package to slide relative to an underlying flexible package as the flexible packages travel from a lower end to an upper end. The device utilizes a drum with radially extending resilient paddles for successively engaging and carrying the flexible packages as the drum rotates. Successive engagements and rotation vibratingly separate the flexible packages and discharge a stream of substantially separated flexible packages.

It is an object of the present invention to provide an improved apparatus for separating and orienting pouched articles with enhanced volume throughput and better control over gapping between adjacent articles than in previously known designs.

### SUMMARY OF THE INVENTION

An apparatus for orienting and sorting pouched articles and has a plurality of inclined conveyors arranged sequentially from a first conveyor to a last conveyor for each conveyor in turn to transport an article up a respective incline and drop the article onto an adjacent of the conveyors from the first conveyor to the last conveyor. The respective incline of the conveyors is sufficient to cause an overlying article to slide relative to an underlying article as the underlying article is transported up the incline. Each conveyor is independently actuatable by a respective actuator. A respective article detector is associated with each conveyor for detecting presence or non-presence of an article thereon. A controller communicates with each article detector and each actuator and causes each conveyor to be stopped until at least an adjacent of the conveyors ahead of it is clear of an article and to be in a transport configuration otherwise.

The actuator may be a motor and the detector may have a sensor which detects electromagnetic waves.

The actuator may be a stepper motor and the detector may be a photo eye.

The conveyors may be arranged in a straight line.

The apparatus may further have an article feeder associated therewith for delivering unsorted articles to the first conveyor. The apparatus may also have an exit stage associated therewith for receiving sorted articles from the last conveyor and further transporting the sorted articles while maintaining a sorted condition.

The article feeder may include a hopper for receiving the articles, the hopper having a discharge outlet, and a primary feed bowl for receiving and orienting the articles and for discharging the articles onto a first feed conveyor. A vibrating conveyor may extend between the hopper and the primary feed bowl for transporting the articles from the discharge outlet to the primary feed bowl. The first feed conveyor may extend between the primary feed bowl and the first conveyor for transporting the articles from the primary feed bowl to the first conveyor.

The apparatus may also have a secondary feed bowl interspersed among the plurality of inclined conveyors to divide the plurality of inclined conveyors into first and second arrays, each having at least two of the plurality of inclined conveyors. A second feed conveyor may extend between the secondary feed bowl and the second array. The secondary feed bowl may be configured to receive articles from the first array, orient the articles and discharge the articles onto the second feed conveyor. The second feed conveyor may be arranged to transport the articles from the secondary feed bowl to the second array.

The exit stage may have a discharge and staging conveyor which receives articles from the last conveyor. The staging conveyor may communicate with and be controlled by the controller to receive and discharge predetermined groupings of the articles.

### DESCRIPTION OF DRAWINGS

Preferred embodiments of the invention are described below with reference to the accompanying drawings in which:

FIG. 1 is schematic representation illustrating sorting by utilizing an array of inclined conveyors according to the present invention;

FIG. 2 is a top plan view illustrating a single stage apparatus according to the present invention;

FIG. 3 is a front elevation of the apparatus of FIG. 2;

FIG. 4 is a top plan view illustrating a two stage apparatus according to the present invention; and,

FIG. 5 is a front elevation of the apparatus of FIG. 4.

### DESCRIPTION OF PREFERRED EMBODIMENTS

An apparatus according to the present invention for sorting articles, and in particular pouched articles is generally indicated by reference 10. The apparatus 10 includes a plurality of inclined conveyors 12 which are arranged sequentially from a first conveyor 14 to a last conveyor 16. Each conveyor has a lower end 18 and an upper end 20. The upper ends 20 of all but the last conveyor 16 overlap the lower end 18 of the adjacent of the inclined conveyors 12 whereby an article 30 may be conveyed up each inclined conveyor 12 in turn and dropped onto an adjacent of the conveyors 12 in turn from the first conveyor 14 to the last conveyor 16.

Each conveyor 12 has an actuator 40 which may for example be a DC motor, such as a stepper motor. The actuator 40 communicates with a controller 50 which can cause each actuator 40 to cause the conveyors 12 to be in a transport configuration in which it transports the articles 30. The controller 50 can further cause each actuator 40 to cause its respective conveyor 12 to be in a stopped configuration wherein it ceases movement. Different types of actuator may be used to start and stop movement of the conveyors 12, for example power may be provided or interrupted to a motor or a clutch may be engaged and disengaged as required.

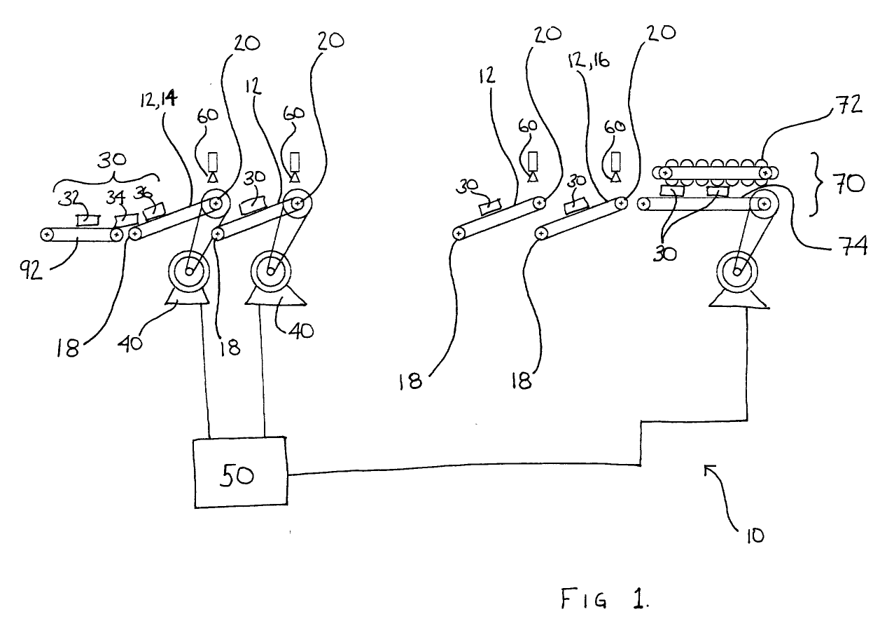

FIG. 1 illustrates how sorting is effected by the inclined conveyors 12. Toward the left of FIG. 1, are three bunched up articles generally identified by reference 30 and specifically identified by references 32, 34 and 36. The movement of the first conveyor 14 acts to pull the articles 30 up the first conveyor 14. Gravity acts to cause the articles 30 to slide back down the first conveyor 14. The coefficient of friction between the inclined conveyors 12 and the article 36 is selected to exceed that between the articles 32, 34 and 36. Accordingly, article 36 will pull up the first conveyor 14 while article 34 will tend to slide back down over article 32. Article 32 will next pull up the inclined conveyor 14 followed by article 34. It will be apparent that the amount of incline will vary depending upon the article in question. It should be enough to cause the upper articles 30 of the bunches articles 30 to slide down the underlying articles 30, but not so much as to cause the underlying of articles 30 to tumble back down.

The first conveyor 14 drops the article 36 onto the conveyor 12 immediately adjacent thereto. Presence of the article 36 on the adjacent inclined conveyor 12 is sensed by a photo eye 60. Presence of the article 36 causes the photo eye 50 to send a signal to the controller 50 to cause the first conveyor 14 to cease moving (i.e. to be in its stopped configuration). This enables the remaining inclined conveyors 12 to transport the article 36 to a staging conveyor 70 which receives the article 36 from the last conveyor 16.

The above sequence may be repeated for article 32 and then again for article 34. The staging conveyor 70 may be advanced incrementally for each sequence until a predetermined number of the articles 30 are staged, at which point the staging conveyor 70 may be actuated to discharge the articles 30. The staging conveyor may have an upper belt 72 and a lower belt 74 to maintain spacing between the articles 30. The staging conveyor may also communicate with and be controlled in its operation by the controller 50.

The above sequence may be sped up somewhat by configuring the controller to cause each actuator 40 to actuate its respective inclined conveyor 12 (i.e. to put it in its transport configuration) as long as the immediately adjacent of the conveyors 12 is clear. In the above example this would mean that the articles 36, 32 and 34 would be on respective adjacent conveyors 12 as they go through the sorting apparatus 10 rather than being fed through individually. This allows for several sorting stages and requires a photo eye 60 associated with each of the inclined conveyors 12.

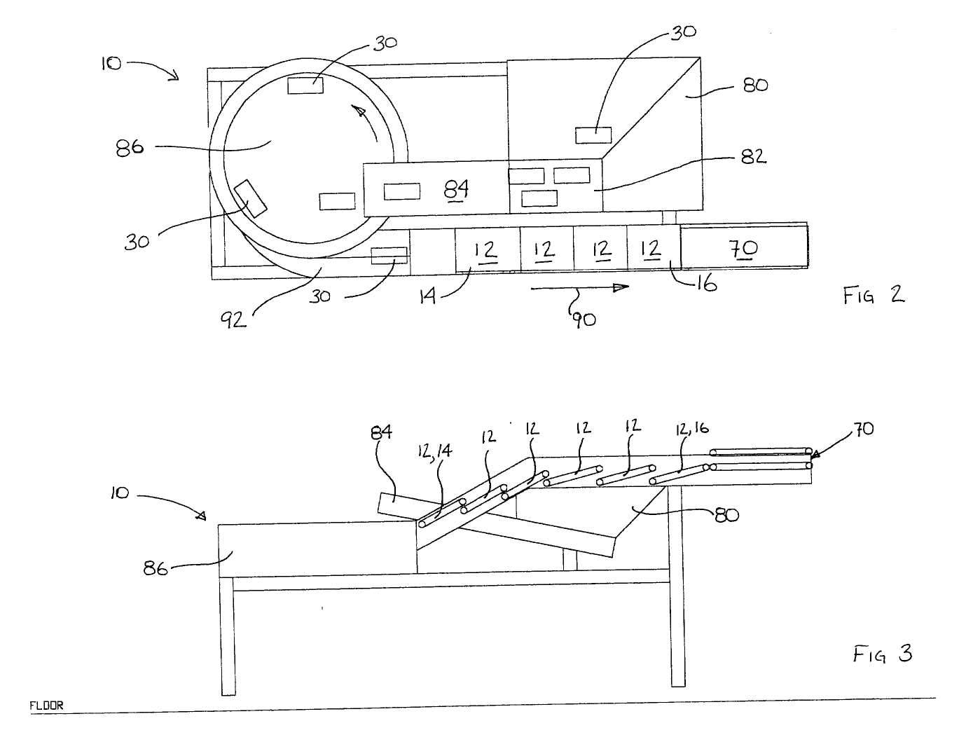

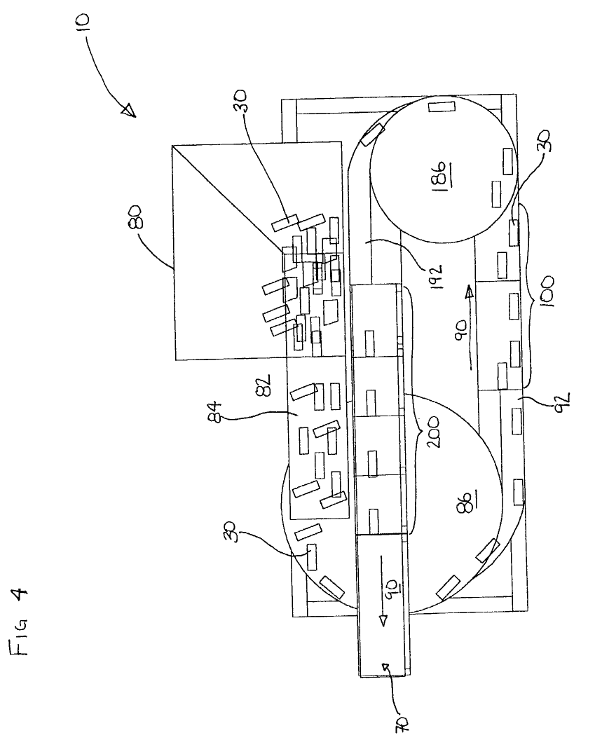

The speed and effectiveness of the sorting apparatus 10 generally increases with the number of inclined conveyors 12. It is expected that two might work however, three or more are preferred. The apparatus 10 may also be a single stage design as illustrated in FIGS. 2 and 3 with one array of inclined conveyors 12, or a two-stage design having a first array 100 of inclined conveyors 12 and a second array 200 of inclined conveyors 12. The single stage arrangement will be discussed first.

FIGS. 2 and 3 illustrate one manner in which the articles 30 may be delivered to the first conveyor 14. According to this embodiment, an article feeder is utilized which has a hopper 80 which receives the articles 30 and discharges them through a discharge outlet 82 at the bottom thereof onto a vibrating conveyor 84 which in turn transports the articles 30 to a primary feed bowl 86.

The primary feed bowl 86 is basically a rotating drum which causes the articles 30 to be hurled radially outwardly and to orient the articles 30 with respective long sides thereof generally aligned with the travel direction of the apparatus 10, as indicated by arrows 90.

The primary feed bowl 86 discharges the articles 30 onto a first feed conveyor 92 which extends between the primary feed bowl 86 and the first conveyor 14. The first feed conveyor transports the articles 30 from he primary feed bowl 86 to the first conveyor 14 of the inclined conveyors 12.

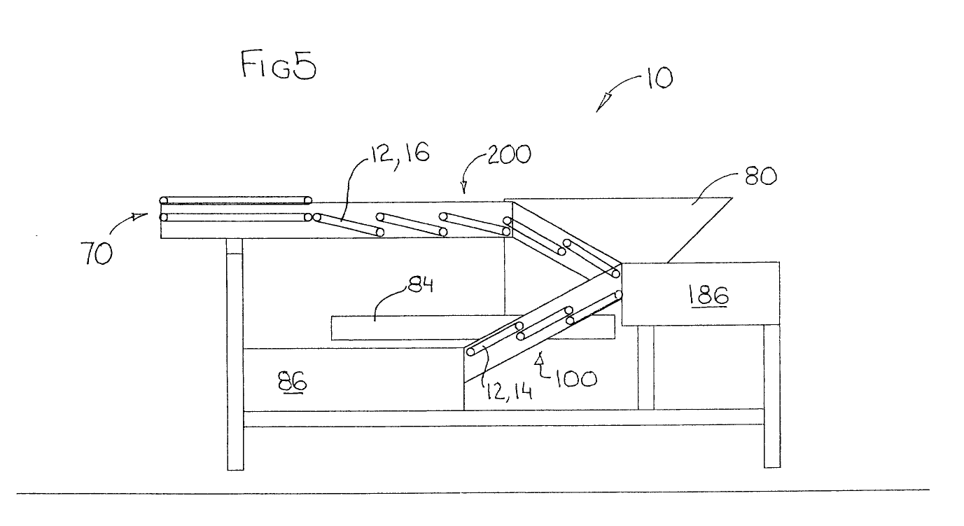

FIGS. 4 and 5 illustrate a two stage embodiment of the apparatus 10 in which a secondary feed bowl 186 is provided and interspersed among the inclined conveyors 12 to define the first array 100 and the second array 200 referred to above. The secondary feed bowl 186 may be structurally and operationally similar to the primary feed bowl 86. The secondary feed bowl 186 transfers the articles between the first array 100 and the second array 200 and enables a redirection of the articles 30. For example, in FIGS. 4 and 5 the secondary feed bowl transfers the articles 30 between the first array 100 and the second array 200 each of which transports the articles 30 in opposite directions.

A second feed conveyor 192 extends between the secondary feed bowl 186 and the second array 200. The second feed conveyor is arranged to transport the articles 30 from the secondary feed bowl 186 to the second array 200.

It has been found in practice that a two-stage arrangement can handle a significantly greater volume throughput than can a single stage arrangement.

The above description is intended in an illustrative rather than a restrictive sense. Variations to what has been described may be apparent to persons skilled in material handling and sorting apparatus without departing from the spirit and scope of the invention as defined by the claims set out below.

For example, other arrangements may be possible for feeding and removing the articles 30 to and from the inclined conveyors 12. Different actuators and article detectors than those described may in some circumstances be better suited in adapting the apparatus 10 to specific applications.

1. An apparatus for sorting pouched articles comprising:
a plurality of inclined conveyors arranged sequentially from a first conveyor to a last conveyor for each said conveyor in turn to frictionally engage and transport an article up a respective incline and drop said article onto an adjacent of said conveyors from said first conveyor to said last conveyor;
said respective incline and the frictional engagement between said articles and said conveyors being sufficient to cause an overlying article to slide relative to an underlying article as said underlying article is transported up said incline;
a respective, independently actuatable actuator connected to each said conveyor;
a respective article detector associated with each said conveyor for detecting presence and non-presence of said article respectively thereon; and,
a controller communicating with each said article detector and each said actuator and configured to cause each said conveyor to be in a respective stopped configuration until at least an adjacent of said conveyors ahead thereof is clear of said article and to be in a transport configuration otherwise.

2. The apparatus of claim 1 wherein:
said actuator is a motor;
said detector has a sensor which detects electromagnetic waves.

3. The apparatus of claim 2 wherein:
said actuator is a stepper motor;
said detector is a photo eye.

4. The apparatus of claim 3 wherein:
said conveyors are arranged in a straight line.

5. The apparatus of claim 1, 2, 3 or 4 further having:
an article feeder associated therewith for delivering unsorted of said articles to said first conveyor; and,
an exit section associated therewith for receiving sorted of said articles from said last conveyor and further transporting said sorted articles while maintaining a sorted condition.

6. The apparatus of claim 5 wherein said article feeder includes:
a hopper for receiving said articles, said hopper having a discharge outlet;
a primary feed bowl for receiving and orienting said articles and discharging said articles onto a first feed conveyor;
a vibrating conveyor extending between said hopper and said primary feed bowl for transporting said articles from said discharge outlet to said primary feed bowl; and,
a first feed conveyor extending between said primary feed bowl and said first conveyor for transporting said articles from said primary feed bowl to said first conveyor.

7. The apparatus of claim 6 further comprising:
a secondary feed bowl interspersed among said plurality of inclined conveyors to divide said plurality of inclined conveyors into first and second arrays, each having at least two of said plurality of inclined conveyors; and
a second feed conveyor extending between said secondary feed bowl and said second array;
said secondary feed bowl being configured to receive said articles from said first array, orient said articles and discharge said articles onto said second feed conveyor;
said second feed conveyor being arranged to transport said articles from said secondary feed bowl to said second array.

8. The apparatus of claim 6 wherein:
said exit stage has a discharge and staging conveyor for receiving said articles from said last conveyor;
said staging conveyor communicates with and is controlled by said controller to receive and discharge predetermined groupings of said articles.

9. The apparatus of claim 7 wherein:
said exit stage has a discharge and stating conveyor for receiving said articles from said last conveyor;
said staging conveyor communicates with and is controlled by said controller to receive and discharge predetermined groupings of said articles
